(19) United States
(12) Patent Application Publication
(10) Pub. No.: US 2014/0311093 A1
(43) Pub. Date: Oct. 23, 2014

(54) INTEGRATED QUALITY CONTROL OF CONSUMABLE MATERIALS FOR PACKAGING MACHINES

(71) Applicant: KRONES AG, Neutraubling (DE)

(72) Inventors: Wolfgang Huber, Grafing (DE); Johannes Boehm, Regensburg (DE)

(73) Assignee: KRONES AG, Neutraubling (DE)

(21) Appl. No.: 14/346,560

(22) PCT Filed: Sep. 12, 2012
(86) PCT No.: PCT/EP2012/067853

§ 371 Date: Jul. 2, 2014

(30) Foreign Application Priority Data
Sep. 30, 2011 (DE) 10 2011 054 080.6

(51) Int. Cl. B65B 57/18; B65C 9/40; B65C 9/46; B65B 57/02

(52) U.S. Cl. CPC B65B 57/18; B65B 57/02; B65C 9/40; B65C 9/46
USPC 53/415; 53/136.1; 53/167; 53/507; 53/131.2; 53/461

(57) ABSTRACT

A device is provided for applying consumable materials to containers, including a storing apparatus that stores a supply of the consumable material, a transporting apparatus that conveys the consumable material to the containers, and an application unit that applies the consumable material to the containers or to combinations of containers. The device has at least one sensor apparatus, which detects at least one actual value of the consumable material that is characteristic of a physical property of the consumable material, a comparing apparatus, which compares the detected actual value with at least one target value stored in a memory apparatus, and a signal outputting apparatus, which outputs a signal according to a result of said comparison.

The present invention relates to an apparatus for the application of consumable materials to and/or with containers. Apparatus of this type have long been known from the prior art. In this way, for example, labelling machines apply labels to containers or packaging machines pack individual bundles or a plurality of bundles in films, such as for example shrink films. In addition, machines are also known which provide containers with packaging, for example cardboard packaging. In this case with these machines a consumable material is used in each case, such as for example labels, shrink films, cardboard and the like, which are applied with or to the containers.

Packaging machines of this type thus use packaging materials in daily operation. The producers of the machines usually specify in this case the requirements and the quality of the consumable materials in the form of material specifications. Promises of guarantee can also be made to the customer or the machine operator on the basis of such material specifications. Frequently, however, the problem arises that the consumable materials which are actually delivered by third parties or by suppliers do not meet the criteria which are necessary for the processing of the consumable material. A consequence of this is that it is necessary in part for consumable materials to be processed which are outside the pre-set tolerance range. This in turn can result in machine breakdowns of which the cause can frequently, however, be traced back to the varying quality of the consumable material only with difficulty.

A labelling machine is known from DE 103 06 671 A1 which has an inspection, printing or alignment module which forms an interchangeable unit. In this way, this machine can be rapidly converted to different types of labels.

An apparatus for inspecting labels on containers is known from DE 20 2005 020 478 U1. In this case, however, the supplied labels are not inspected, but they are inspected only when they are already arranged on the containers, for example just in order to check this correct arrangement.

The object of the present invention is therefore to achieve a higher degree of safety from faults in the case of packaging machines of this type which use the aforesaid consumable materials.

The object stated above is attained by apparatus and methods according to the independent claims. Advantageous embodiments and further developments form the subject matter of the sub-claims.

An apparatus according to the invention for the application of consumable materials to containers has a storage device which stores a stock of the consumable material, as well as a conveying device which conveys the consumable material to the containers. In addition, the apparatus has an application unit which applies the consumable material to the containers or to sets of containers.

According to the invention the apparatus has at least one sensor device which detects at least one actual value of the consumable material which is characteristic of a physical property of the consumable material, as well as a comparator device which compares the detected actual value with at least one nominal value stored in a store device, and with a signal output device which emits a signal in a manner dependent upon a result of this comparison.

The application device can be for example a labelling unit which applies the labels to the containers. It can also, however, be a unit which for example applies shrink films or the like to the containers or to groups of containers. In addition, it would be possible for the application unit to be a closure device which provides the containers with closures. In addition, it can be a cartoning unit which forms cartons for the respective containers.

It is therefore proposed to introduce an integrated quality control for consumable materials. This comprises the aforesaid sensor device which detects values which are characteristic of the quality of the consumable materials to be currently processed. In this case consumable materials are to be understood in particular as being those materials which—in contrast to the containers for example—cannot be re-used as a rule. It is advantageous for these to be solid materials, but it would also be possible for the invention to be applied to liquid materials such as for example paints or adhesives. The application of the consumable material to and/or with containers is to be understood, in particular, as that a physical connection, in particular a releasable connection, is produced between the consumable material and the containers and/or groups of containers. It is preferable for this to be a connection which is released for the purpose of opening and/or unpacking the container.

The signal emitted in a manner dependent upon the result can be for example a warning signal. In addition, this can be a signal which causes the apparatus to stop. In addition, the signal can be a sign to the user that proper material is not being used. In the case of a preferred embodiment the apparatus has a plurality of sensor devices which detect a number of properties of the consumable material. It is advantageous for the results of these sensor devices to be compared in each case with nominal values by means of comparator devices.

In the case of a preferred embodiment the signal output device is designed in such a way that it emits for example a signal capable of being perceived by a user if there is a deviation of the actual value from the nominal value over a pre-set threshold value. It is also possible, however, for a signal to be given to a control device which controls the apparatus in reaction to this signal.

Tolerance limits can therefore be set within which the respective actual values must lie. In the event of deviation of such an actual value the signal can be emitted. If a plurality of sensor devices are present, it would be possible for the signal to be emitted if the deviation of one of the actual values from the nominal value is over a pre-set threshold value. It would also be possible for logic links to be additionally implemented and for example also for a signal to be emitted if there are a plurality of deviations even though the deviation of two or more actual values taken individually is not over the pre-set threshold value.

It is therefore advantageous for a plurality of actual values to be determined with sensor devices which are advantageously different, and not only for these individual actual values to be compared with nominal values but also for the actual values or the respective comparison results to be linked to one another logically.

In the case of a further advantageous embodiment the sensor device is arranged between the storage device and the application unit in the conveying direction of the consumable material. It is advantageous for the sensor device to be arranged close to the storage device in the conveying direction of the consumable material. As a result of this close arrangement it is possible to detect faults early and to react to them accordingly.

In the case of a further advantageous embodiment the apparatus has a detection unit which, if there is a deviation of the actual value from the nominal value over a pre-set threshold value, detects and/or emits data which are characteristic of the time of occurrence of this deviation. In this way, it is possible for example to determine when (date and precise time) a specific fault has occurred. It would also be additionally possible for further data to be jointly detected, such as for example room temperature, an operating speed of the machine, a filling state of the storage unit and the like.

In the simplest case the storage device can be for example a tray on which the stock of the consumable material is arranged. This facility can also be the floor of a machine shop. Further possibilities for these storage units are for example rolls on which the material is wound up and the like.

In the case of a further advantageous embodiment the apparatus has a marking unit which in particular applies a marking to the consumable material if there is a deviation of the actual value from the nominal value over a pre-set threshold value. In this way, it would be possible for example for a suitable marking to be applied to the consumable material by means of a printer which operates for example by means of an invisible UV ink or even a different visible or invisible printing medium, and for this marking preferably to be applied permanently.

In this way, an identification of the faulty material is also possible subsequently. Furthermore, it would also be possible for the user to be additionally asked by the machine to remove part of the consumable material and to record and where appropriate also to confirm by a signature that this material has been used at a specific time in a specific machine. Furthermore, it would also be possible in a first step for a warning report to be displayed, for example on a screen, from which it is evident that the consumable material is outside the tolerance. The marking unit could also, however, apply other types of markings, such as for example punch-outs, laser markings, thermal stamps and the like.

Furthermore, it would also be possible for a specific portion of the consumable material to be separated out, for example a residual portion of a roll of labels used in a corresponding manner or even individual pieces in the case of cardboard packages. It would be possible for example for a cardboard blank, the properties of which are outside the threshold values, to be separated out. In addition, a cardboard blank of this type could be provided by the machine with an imprint, such as a stamp, from which the date of the separation out is also evident. A blank of this type could also be used as evidence in a subsequent process.

In the case of a further advantageous embodiment the apparatus has a fault detection device which in the event of a fault occurring emits data characteristic of this fault. In this way it would be possible, in the event of specific faults of the machine which need not necessarily lead to a stoppage of the machine for example, for a record to be made of when exactly the fault occurred. In this way it would be possible for specific consumable materials, the properties of which are outside tolerance limits, also to have specific faults assigned to them. These data too can be stored in this case in a store device.

In the case of a further advantageous embodiment the actual value which is characteristic of the physical property is formed from a group of physical properties which comprises a temperature of the consumable material, a thickness of the consumable material, transparency properties of the consumable material, deposits on the consumable material, a number of markings on the consumable material, a static charge of the consumable material, a geometrical shape of punch-outs of the consumable material, the presence of chads in or on the consumable material, the tolerances of blanks, combinations thereof and the like.

In this way, it would be possible for example for apparatus (for example so-called sniffers) to be provided for detecting paint evaporation. It is advantageous for the evaluation of these measurement results to be carried out on-line, for example on an operating panel of the machine. In this case it is possible for a measurement report to be created in a manner capable of being exported for further use with the supplier.

In this way, it is possible for the user of the machine to specify the quality of the consumable material. In this case it is also possible for a random sample testing to be carried out on receipt of the goods. In this way, fluctuation in the quality can be detected on-line on the consumable material and can go as a complaint to the supplier immediately after processing. This can lead to an increase in the quality of the consumable material and thus [to] an increase in the efficiency of the machine or even for example a partial refund of the purchase price on account of defective goods.

Furthermore, a targeted study of the causes in the case of problems with packaging machines can also be carried out by the machines. By means of a precise logging it is possible for faults caused by consumable material on the machines also to be assigned to the correct cause. A reduction in the quality costs can be achieved in this way.

In the case of a further advantageous embodiment the sensor device detects a value characteristic of a length of the consumable material. In particular, a value is detected in this case which is characteristic of a length of the material moved past the sensor device. Besides or in addition, a value can also be detected which is characteristic of a piece number of the consumable goods. If the consumable material is for example a roll of labels or film (in which for example the labels follow in succession) a value can be detected which is characteristic of the number of the individual labels (and thus also of the length of a corresponding strip of material).

It is advantageous for a suitable sensor device for detecting the length to be arranged immediately after a store device for the consumable material, for example immediately after a corresponding roll of labels or film.

In the prior art the operator has to record a plurality of production data on a production plan during production. Since the actual and the nominal quantity of material of the suppliers can fluctuate widely, the operator has to compare the actual number of the quantity present in the carton or roll with the printed number on the roll or carton, note it and inform the shift foreman in order to be able to claim this from the supplier if necessary. The data must be transmitted before a product change and during a shift change.

To this end, the operator can note the quantity of material consumed with reference to the production counter (determination with reference to the cut labels in the case of a labelling machine) and can compare this with the printed number on the roll. If the operator threads a label in by hand, however, a couple of metres of spoiled film caused by the threading are always cut off. In this way, an exact actual value is no longer capable of being achieved.

In the case of a packing means the quantity of material consumed (applied metres of film on a cardboard roll) is not determined. The production counter determines only the number of bundles supplied.

In the case of the embodiment described above or a corresponding method, the sensor device (which is preferably arranged directly after the roll of film) likewise determines the length of the consumable material wound off. In the case of labels the number of the labels can also be determined with reference to cutting marks.

Before a new loading of material the operator can input, or scan, into the machine control means the quantity of material printed by the supplier. The respective machine then automatically determines with reference to the sensor device the deviation of the actual value and the nominal value and reports this to the operator (for example by a signal to the control unit of the machine, or by way of a mobile operating unit). These data are advantageously additionally collected in a software tool and can then be evaluated statistically.

The present invention further relates to a method of applying consumable materials to and/or on and/or with containers, in which a consumable material is conveyed starting from a storage unit to an application unit and the application unit applies the consumable material on or to containers or on or to sets of containers. According to the invention at least one actual value which is characteristic of a physical property of the consumable material is determined or detected respectively by means of a sensor device and this actual value is compared with a nominal value and a signal is emitted on the basis of this comparison.

It is therefore also proposed with respect to the method that the properties of the consumable material should be investigated and the respective signals should be emitted in a manner dependent upon these investigations.

In the case of a preferred method the actual value is detected during the conveying of the consumable material from the storage unit to the application unit. It is advantageous for the actual value to be detected during a movement of the consumable material (in the conveying direction thereof).

It is advantageous for the actual value to be stored and in a particularly preferred manner together with information which is characteristic of its occurrence. This is, as mentioned above, in particular information relating to time or also in conjunction with the checked consumable material. In the case of a further preferred method a marking from which the actual value is preferably also evident is applied to the consumable material.

In the case of a further advantageous method a plurality of physical properties of the consumable material is detected and the respective characteristic actual values are compared with nominal values in each case.

Further advantages and embodiments are evident from the accompanying drawings. In the drawings

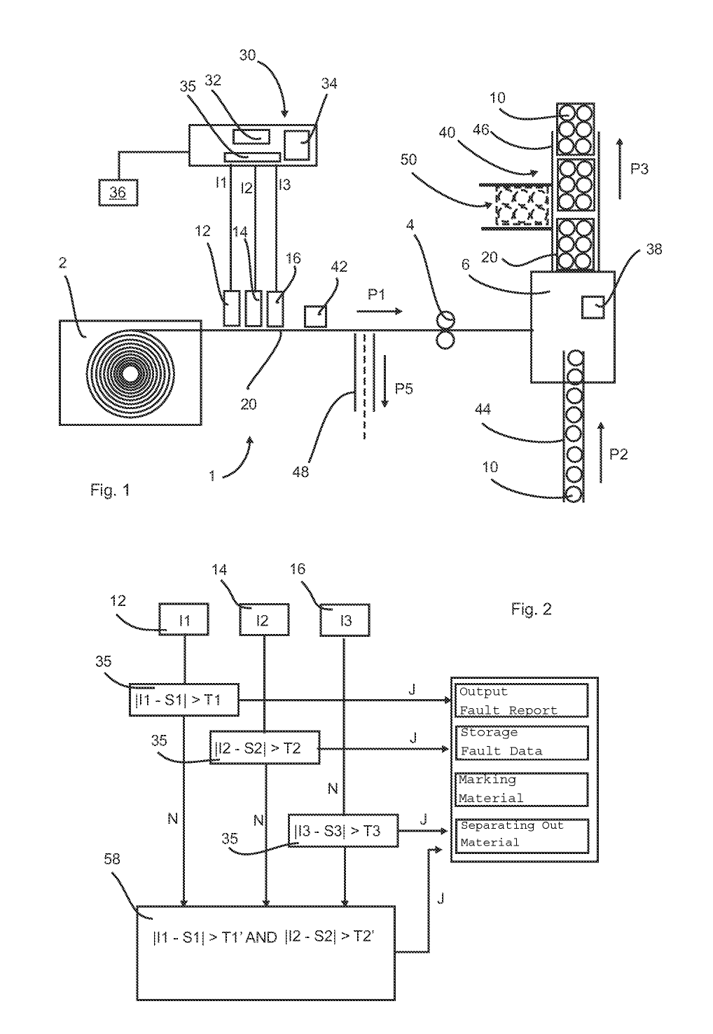

FIG. 1 is a diagrammatic illustration of an apparatus according to the invention, and

FIG. 2 is a diagrammatic flow chart of a method according to the invention.

FIG. 1 is a diagrammatic illustration of an apparatus 1 according to the invention for the application of consumable materials 20 to and/or with containers 10. The reference number 2 designates in this case a storage unit in which is stored the consumable material 20 which in this case can be for example a strip of labels or even shrink film. Starting from this storage device 2 the consumable material 20 is conveyed by means of a conveying device 4 (shown only diagrammatically) to an application unit 6 (likewise shown only diagrammatically).

In addition, containers 10 are also supplied along the arrow P2 to the application unit 6. In this way, it is advantageous for a conveying device 44 also to be provided for conveying the containers. The application unit 6 now applies the consumable material 20 to the containers. In the case of the arrangement shown in FIG. 1, groups are formed from 6 containers in each case and are then packed into the consumable material 20. The reference number 40 designates the set formed in this way from the containers 10 on the one hand and the consumable material 20 on the other hand.

The reference number 46 designates a conveying device which in turn conveys these sets 40 from the application device 6. The reference P3 designates the direction in which the sets 40 are conveyed from the application device 6 and the reference P2 designates the supply direction for the containers. The reference P1 refers to the conveying direction of the consumable material 20.

The storage unit 2 has provided downstream of it in the conveying direction P1 three sensor devices 12, 14 and 16, which in each case detect characteristic parameters of the consumable material, as mentioned above, for example a static charge, a transparency or the presence of specified markings. These sensor devices 12, 14 and 16 accordingly emit actual values I1, I2, I3 in each case, or signals which are characteristic of such actual values, respectively.

These actual values are fed to a comparator device 35 which itself in turn is a component part of a control device 30. The actual values are compared with nominal values or reference values respectively by means of this comparator device 35. These nominal values can be stored in a store device 32 in this case.

It is possible to determine from this comparison whether the consumable material 20 meets pre-set criteria. If the actual values deviate from the nominal values more than beyond a specified amount, this can be displayed by way of a display device or signal emission device 34, and/or a warning signal, and in particular a warning signal which is capable of being perceived physically by a user, can be emitted to the user.

The reference number 36 relates to a further sensor device which detects an actual value which is independent of the consumable material 20, such as for example an external temperature, an external pressure and the like.

The reference number 38 relates to a sensor device which determines at least one operating parameter or operating actual value of the application unit, such as a slippage of the consumable material with respect to conveying elements. In addition, it would be possible to determine a multiplicity of operating parameters of this type. It is preferable for these operating parameters to be detected jointly with the time of the occurrence thereof. In this way, it is possible to determine the manner in which deviations of the consumable material from pre-set standards affect the operation of the application unit. These recorded operating parameters can also be forwarded to the control device 30. It is advantageous for this sensor device 38 to be a fault detection device which detects a fault of the application unit 6. In this case this fault detection device can also record further data characteristic of the fault of the application unit, such as for example a time duration of the fault or a time duration of a stoppage of the apparatus 1.

It is advantageous for at least one of the sensor devices to detect the actual value in a contact-less manner, i.e. without contact with the consumable material.

A printing device 42, which is capable of printing on the consumable material 20, adjoins the sensor device. It is advantageous for this printing device 42 also to be controlled by the control device 30 and then to provide the consumable material 20 with an imprint if the properties thereof deviate from the properties required.

Other marking units would also be possible, however, such as for example stamping units. In this case the control device 30 can also have a timer, so that the marking can also be carried out in conjunction with a time value. In addition, the application unit 6 can likewise have sensor devices which determine those parameters which are characteristic of the application procedure of the consumable material on the containers. These parameters too are advantageously recorded in this case together with a time reference. In this way, a specific fault can also be assigned in each case to a faulty consumable material 20.

The reference number 48 designates a first separating device by which—in the event of unsuitable material occurring—this consumable material can be separated out along the arrow P5. In this way, in the event of claims for compensation against suppliers later, it is possible to provide the proof that a specific fault or a specific deviation of actual values from nominal values has occurred in the consumable material 20. The separating device 48 can be controlled in such a way in this case that a remainder of a spread of the consumable material recognized as being defective is separated out. For this purpose, the storage unit 2 can have a detection device for detecting a filling state of the consumable material. In this way, it would be possible for example to separate out cardboard blanks of a spread recognized as being defective. The materials separated out respectively could likewise be provided with a marking in this case.

If it is not possible to separate out the consumable material, it would also be conceivable for a container separation device 50 to be provided (as well as or instead of the first separation device 48) which separates out those containers and/or bundles which have been processed with a consumable material recognized as being defective. A container separation device 50 of this type is therefore advantageously arranged downstream of the application unit 6 in the conveying direction of the containers. A further marking unit can advantageously be provided which marks the separated containers and/or bundles in the manner described above.

In addition, it would be possible for a container separation device 50 of this type to co-operate with the marking unit 42 described above. If this marking unit 42 for example applies a marking to the consumable material 20, this marking could be detected by a sensor device at a later time (for example if the consumable material has already been applied to the container) and the corresponding container processed with the marked consumable material could be separated out. In addition, it would also be possible for such a separation out of containers 10 and/or sets 40 of containers 10 or even a separation out of consumable material 20 (for example in the control device) to be logged.

FIG. 2 is a possible flow chart for a machine control according to the invention. In this case the actual values I1, I2 and I3 are issued in turn by the sensor devices 12, 14, 16 and these actual values are compared in the comparator device 32 with nominal values S1, S2 and S3 in each case. In the case of the arrangement shown in FIG. 2 the comparison is carried out in regard to whether a difference in quantity between the actual value I1, I2, I3 and the nominal values S1, S2, S3 is smaller or larger in each case than a maximum threshold value T1, T2 or T3. If this is the case, different reactions can be initiated, such as for example the issuing of a fault report, the storage of the fault data, the marking of the material or even the separation of the material for further evidence purposes. If the individual threshold values T1, T2, T3 are not exceeded, it is additionally possible to check by way of a linking module 58 whether for example the actual values I1 and I2 differ more in this case than by the two threshold values T1′ and T2′ (which, in particular, are smaller than the values T1 and T2). If both are the case, the aforesaid steps can be carried out again above.

The Applicants reserve the right to claim all the features disclosed in the application documents as being essential to the invention, insofar as they are novel either individually or in combination as compared with the prior art.

### LIST OF REFERENCES

2 storage unit
4 conveying device
6 application device
10 containers
12, 14, 16 sensor devices
20 consumable material
30 control device
32 store device
34 display device
35 comparator device
36, 38 sensor device
40 set
42 printing device, marking unit
44 conveying device
46 conveying device
48 separation device
50 container separation device
58 linking module
I1, I2, I3 actual values
P1 conveying direction
P2 arrow, supply direction
P3 direction
P5 arrow
S1, S2, S3 nominal values
T1, T2, T3 threshold values
T1′, T2′ threshold values

1. An apparatus for the application of consumable materials to containers comprising: a storage device which stores a stock of the consumable material; with a conveying device which conveys the consumable material to the containers; and with an application unit which applies the consumable material to the containers or to sets of containers, wherein the apparatus has at least one sensor device which detects at least one actual value of the consumable material which is characteristic of a physical property of the consumable material; a comparator device which compares the detected actual value with at least one nominal value stored in a store device; and a signal output device which emits a signal in a manner dependent upon a result of this comparison.

2. The apparatus according to claim 1, wherein the signal output device is designed in such a way that it emits a signal capable of being perceived by a user if there is a deviation of the actual value from the nominal value over a pre-set threshold value.

3. The apparatus according to claim 1, wherein the sensor device is arranged between the storage device and the application unit in the conveying direction of the consumable material.

4. The apparatus according to claim 1 with a detection unit which, if there is a deviation of the actual value from the nominal value over a pre-set threshold value, detects and/or emits data which are characteristic of the time of occurrence of this deviation.

5. The apparatus according to claim 1, wherein the apparatus has a marking unit which in particular applies a marking to the consumable material if there is a deviation of the actual value from the nominal value over a pre-set threshold value.

6. The apparatus according to claim 1, wherein the apparatus has a fault detection device which in the event of a fault occurring emits data characteristic of this fault.

7. The apparatus according to claim 1, wherein the sensor device detects a value characteristic of a length of the consumable material.

8. The apparatus according to claim 1, wherein the actual value is characteristic of a physical property which is selected from a group of physical properties which comprises a temperature of the consumable material, a thickness of the consumable material, deposits on the consumable material, a number of markings on the consumable material, a static charge of the consumable material, a geometrical shape of a punch-out of the consumable material, the presence of chads in or on the material, tolerances of blanks, combinations thereof and the like.

9. A method of applying consumable materials to containers, comprising: a consumable material is conveyed starting from a storage unit to an application unit; and wherein the application unit applies the consumable material to containers or to sets of containers wherein: at least one actual value which is characteristic of a physical property of the consumable material is detected by means of a sensor device; and this actual value is compared with a nominal value and a signal is emitted on the basis of this comparison.

10. The method according to claim 9, wherein the actual value is detected during the conveying of the consumable material from the storage unit to the application unit.

11. The method according to claim 9, wherein the actual value is stored, advantageously with information which is characteristic of its occurrence.
